(19) United States
(12) Patent Application Publication
(10) Pub. No.: US 2005/0210522 A1
(43) Pub. Date: Sep. 22, 2005

(54) Remote video-on-demand digital monitoring system

(76) Inventors: Quen-Zong Wu, Taoyuan (TW); Yu-Pin Chen, Taoyuan (TW); Jun-Wen Chen, Taoyuan (TW); Ta-Wei Chien, Taoyuan (TW); Wei-Yuan Cheng, Taoyuan (TW)

Correspondence Address: RABIN & BERDO, P.C., Suite 500, 1101 14 Street, N.W., Washington, DC, 20005, US

(21) Appl. No.: 10/800,639

(22) Filed: Mar. 16, 2004

(51) Int. Cl. H04N 7/173; G06F 15/177; H04N 7/18; H04N 7/16

(52) U.S. Cl. 725/93; 725/87; 725/86; 725/1; 709/222

(57) ABSTRACT

A remote video-on-demand digital monitoring system principally includes an image capture module, a server relay module and a video-on-demand module. The image data of said image capture module are stored in the server relay module through a telecommunication network. Through the telecommunication network, customers can browse the monitored web pages of the video-on-demand module via a browser, and view or store the monitored image data at a desired time segment according to a video-on-demand or movies-on-demand mode.

### BACKGROUND OF THE INVENTION

1. Field of the Invention

This invention relates to a remote video-on-demand digital monitoring system, and in particular, to a remote video-on-demand digital monitoring system which is widely used in the monitor on intersections, the monitor and control of entrance guards, the monitor and management of parking lots and any other areas requiring entry/exit control of people and vehicles.

2. Description of the Prior Art

Currently, many digital monitoring systems associated with the entry/exit control of people and vehicles are implemented by recording to a hard disk or a videocassette using a recording machine and keeping under surveillance by the workers on the spot. Since the surveillant fails to go on duty all the day, such monitoring system is full of loopholes due to negligence or carelessness. If a controversial issue occurs, the recorded videocassette is the only evidence. Even if the worker on duty fails to put the videocassette in the recording machine, this monitoring system is completely collapsed. With the increasing development of technologies, another technology has been developed in replace of the workers' surveillance on the spot. According to such a technology, the image data from a digital video camera is captured by a video server, and subsequently stored into a digital server via a telecommunication network. The digital server is browsed by the workers via the web pages so as to achieve the purpose of monitoring the image data. As such, the workers need not to be on the spot. If a controversial issue occurs, the image data stored in the digital server should be downloaded via the telecommunication network, and then the desired segments of the image data are selected. The segmental images unable to be browsed on the web pages are broadcasted in real time or recorded.

Nowadays, optical fibers are widely used in the telecommunication network field, and wide-bandwidth telecommunication network is growing very fast. In order to meet the requirement of consumers, the telephone companies in the world are devoted to research the wide-bandwidth and offer services such as telecommunication services, amusements, information services, etc. Therefore, interactive services come to the homes in replace of watching TV passively. Progressively, the customers can tailor the programs to their specific tastes. The time period for waiting advertisement is saved. Also, the monotonous programs can be skipped. Customers can promptly select and play the desired programs according to this technology, which is also referred as a video-on-demand (VOD) or movies-on-Demand (MOD) technology.

Accordingly, the above-described prior art product is not a perfect design and has still many disadvantages to be solved.

In views of the above-described disadvantages resulted from the conventional remote video-on-demand digital monitoring system, the applicant keeps on carving unflaggingly to develop a remote video-on-demand digital monitoring system according to the present invention through wholehearted experience and research.

### SUMMARY OF THE INVENTION

An object of the invention is to provide a remote video-on-demand digital monitoring system based on a digital monitoring technology and a remote video-on-demand technology, in which the image data for an arbitrarily selected date segment can be broadcasted in real time or recorded when the web pages are browsed, thereby achieving the purpose of remote monitor and control.

Another object of the invention is to provide a remote video-on-demand digital monitoring system based on a digital monitoring technology and a remote video-on-demand technology to substitute for the conventional monitoring technology of using a videocassette to record, thereby minimizing management cost and human carelessness.

The above objects of the present invention can be achieved by using a remote video-on-demand digital monitoring system. The remote video-on-demand digital monitoring system includes an image capture modules, a server relay module, a video-on-demand module, etc. Digital video cameras are employed to capture the images of vehicles/people passing therethrough at any time. Via the image capture module, the images of vehicles/people are captured and a series of video image data are then transmitted to the server relay module through a telecommunication network. If the user at an unfixed location wants to view or monitor the frames in real time or previously captured at the places where the video cameras are located, the user may browse web pages built in the video-on-demand module via the telecommunication network and operate the web pages. The user may select and view the date and the time segment. When the download component is pressed down, the ActiveX component (or Java Applet or other component) will notify the server relay module via. Socket or other communication means. The server relay module will transmit the video image data during the date and the time segment to the client web pages via file stream or other means. Meanwhile, the ActiveX component (or Java Applet or other component) of the client web pages will receive the video image data during the date and the time segment, and the video image data are then stored and broadcasted. If a recording component is pressed down, the video image data during the date and the time segment will be broadcasted and stored as a video file with a filename given by the user. If a fast-forward play component is pressed down, the video image data during the date and the time segment will be broadcasted at a broadcast speed given by the user. If a pause component is pressed down, the broadcast of the video image data during the date and the time segment will be paused. If a backward play component is pressed down, the video image data during the date and the time segment will be backwardly broadcasted at a broadcast speed given by the user. If a stop component is pressed down, the broadcast of the video image data during the date and the time segment will be stopped, and broadcast items are recovered to the original place.

### BRIEF DESCRIPTION OF THE DRAWINGS

The drawings disclose an illustrative embodiment of the present invention which serves to exemplify the various advantages and objects hereof, and are as follows:

FIG. 1 is a schematic view of a remote video-on-demand digital monitoring system according to the present invention;

FIG. 2 is an implementation example of the server relay module applied in the present invention;

FIG. 3 is an execution frame of a server relay module according to an implementation example of the present invention;

FIG. 4 is a flowchart of a video-on-demand module according to an implementation example of the present invention;

FIG. 5 is a flowchart of implementing the function of video broadcast according to the present invention; and

FIG. 6 is a monitor frame of a remote video-on-demand digital monitoring system according to an implementation example of the present invention.

### DETAILED DESCRIPTION OF THE PREFERRED EMBODIMENT

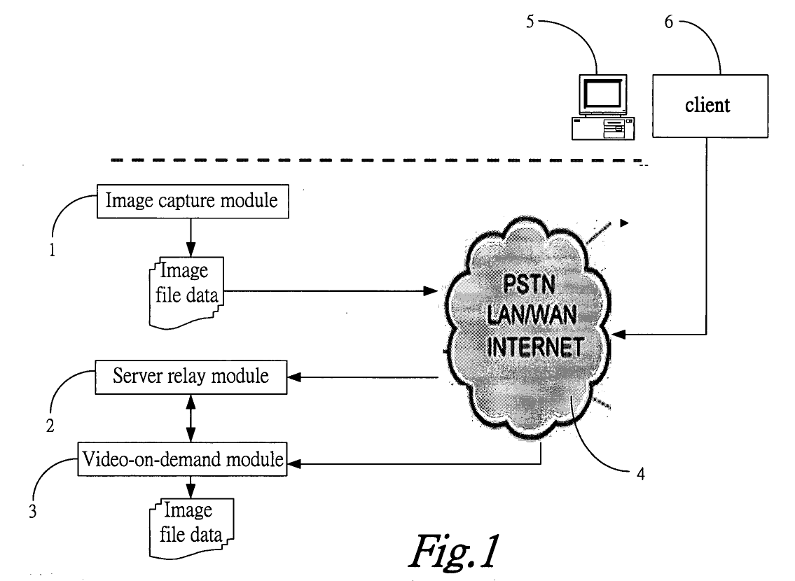

Referring to FIG. 1, a schematic view of a remote video-on-demand digital monitoring system according to the present invention is shown. The remote video-on-demand digital monitoring system includes one or more image capture modules 1, a server relay module 2, a video-on-demand module 3, etc. This system can automatically capture image of vehicles/people. Also, this system can be used to remotely monitor and record video image data on demand.

The video camera can be constructed at the top or lateral of the objects to be captured. When this system is initiated, each image capture module 1 is employed to capture images, and the video image data are immediately transmitted to the server relay module 2 through a telecommunication network 4. The server relay module 2 and the video-on-demand module 3, which is composed of ActiveX, Java Applet or other component) are located at the server side. When the video-on-demand web pages in the server side are browsed by a remote monitoring computer 5 through the telecommunication network 4, the browser will automatically download the video-on-demand module 3 to a client 6 for execution. In addition, in response to a download control command asserted when the user operates the video-on-demand module 3, the server relay module 2 is notified by Socket or other means through the telecommunication network 4. Meanwhile, the server relay module 2 analyses the Socket data or other data, and download the video image data to the client. After the image data are completely downloaded, by selecting the control commands for the video-on-demand module 3, associated operations will be done to broadcast, record, fast-forward play, backward play, pause or stop the video image data.

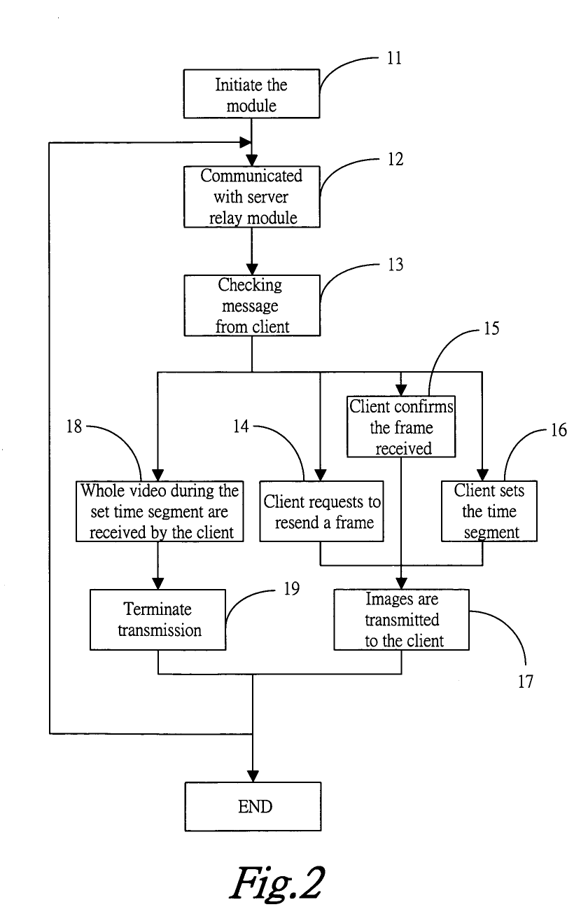

Referring to FIG. 2, an implementation example of the server relay module applied in the present invention is shown. When the module is initiated (11), the server relay module waits to be in communication with the client. After the client is communicated with the server relay module (11), the data segments to be searched and associated with the sent message settings are checked (13). Meanwhile, the server relay module checks whether there are image data during the time segments. If no image data are detected, an end message is sent so as to terminate the communication with the client. If the client requests the server relay module to resend a frame (14) or confirms the frame received (15) or sets the time segment (16), the images will be transmitted to the client in a frame or several consecutive frames (17). During transmission of the image data, the client may return a message indicating that the frame has been received. If the transmission is abortive, the server relay module will reset the same frame to the client. If the whole image data during the set time segment are received by the client, the server relay module may send an end message (18) to terminate the communication with the client (19).

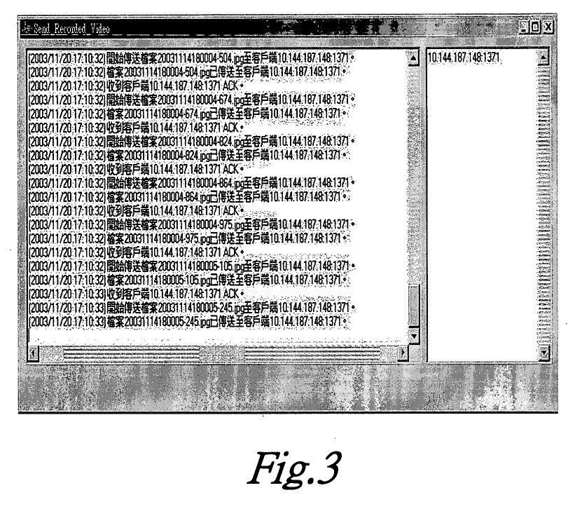

Referring to FIG. 3, an execution frame of a server relay module according to an implementation example of the present invention is shown. The items of the frame include the filename, the date, the time, the client address, the handshake response of the client, etc., which are used for being verified.

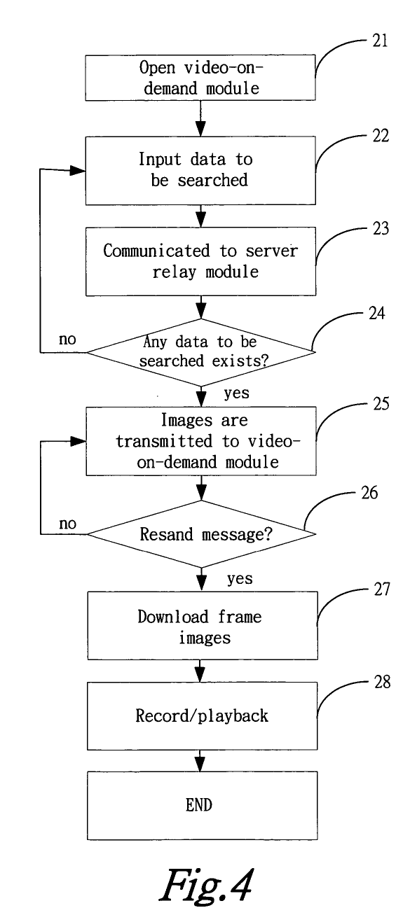

Referring to FIG. 4, a flowchart of a video-on-demand module according to an implementation example of the present invention is shown. After the web page of the video-on-demand module is opened (21), the image data associated with the date and/or the place and/or the time segment and/or the event and/or other key values (for example the vehicle identification number) to be searched are inputted (22). The video-on-demand module will be automatically in communication with the server relay module (23), and check whether there are image data associated with the date and/or the place and/or the time segment and/or the event and/or other key values (24). If no image data are detected, an end message is sent so as to terminate the communication with the server relay module. If image data associated with the date and/or the place and/or the time segment and/or the event and/or other key values are detected, images are transmitted to the video-on-demand module in unitary frame (25). During transmission of the image data, the video-on-demand module may return a message indicating that the frame has been received. If the transmission is abortive, the server relay module will reset the same frame to the video-on-demand module (26). If all frames are completely sent out, the server relay module may send an end message to terminate the communication with the video-on-demand module. During transmission of the images, the user can directly view the downloaded frame images (27) on the web pages. By means of consecutive broadcast, the user can view similar video files on the web pages (28). The video-on-demand module can be composed of ActiveX, Java Applet or other component.

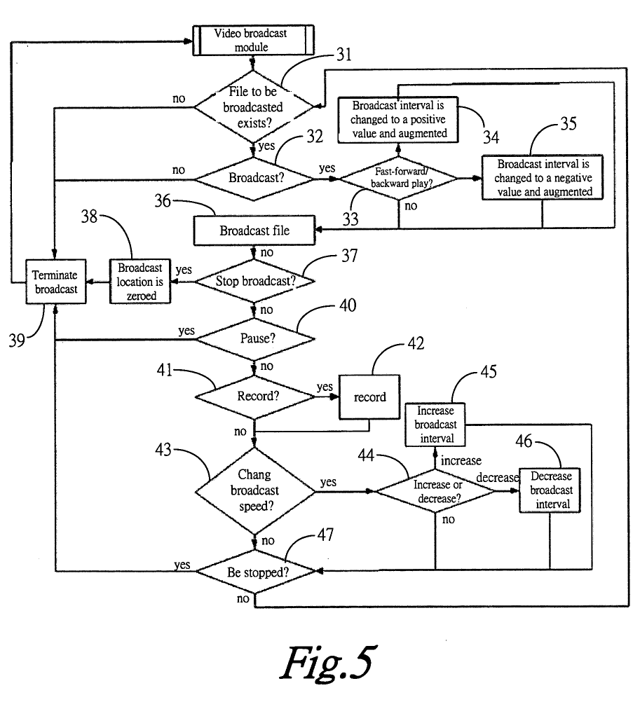

The video-on-demand module can have the function of video broadcast. FIG. 5 is a flowchart of implementing the function of video broadcast according to the present invention. After the frame images are downloaded, the user can determine whether there are files to be broadcasted via the video broadcast module (31). If there is no file to be broadcasted, the broadcast procedure is terminated (39). On the contrary, if there are files, it is further determined whether the files are broadcasted (32) or the broadcast procedure is terminated (39). When the files are decided to be broadcasted, a fast-forward or backward play is selectively done (33). If a fast-forward play is selected, the broadcast interval is changed to a positive value and augmented (34). If a backward play is selected, the broadcast interval is changed to a negative value and augmented (35). Then, the files are broadcasted (36). If no fast-forward or backward play is required to be done, the files are directly broadcasted (36) and further determined whether the broadcast is ready to be stopped (37). If it is determined to stop the broadcast, the broadcast location is zeroed (38) and the broadcast is stopped (39). On the contrary, it is determined whether the broadcast is ready to be paused (40). If it is determined to pause the broadcast, the broadcast is stopped (39). On the contrary, it is then determined whether a recording operation is ready to be done (41). If it is determined to perform the recording operation, the recording operation is done (42). On the contrary, it is further determined whether the broadcast speed is ready to be changed (43). If the broadcast speed is determined to be changed, it is further determined whether the speed is increased or decreased (44). If the speed is to be increased, the broadcast interval is increased (45). If the speed is to be decreased, the broadcast interval is decreased (46) and then it is determined if the broadcast is to be stopped (47). When a determination of not stopping the broadcast is selected, it is further determined whether there are files for broadcast (31). Whereas, when a determination of stopping the broadcast is selected, the broadcast procedure is terminated (39). As such, the user can choose and implement associated operations such as broadcast, fast-forward play, backward play, pause or stop. Even particularly, the user can use ScrollBar or other means to scroll to a desirable location and then perform broadcast. Moreover, the broadcast speed can be optionally selected. During the period of broadcast, the user can select the recording function so as to achieve the purpose of simultaneous broadcast and recording functions.

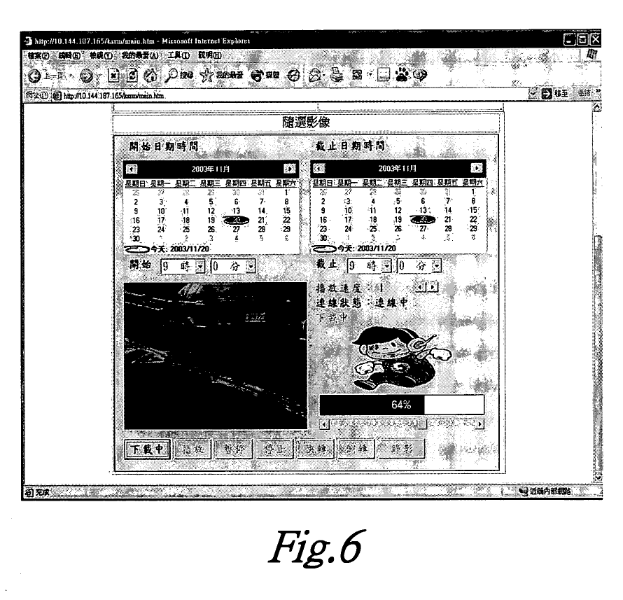

Referring to FIG. 6, a monitor frame of a remote video-on-demand digital monitoring system according to an implementation example of the present invention is shown. The items shown in the frame include date/time/place components, a broadcast speed component, a broadcast frame, fast-forward play/backward play/pause/stop components and a scroll-type of fixed-point broadcast component so as to record on demand and monitor.

The remote video-on-demand digital monitoring system provided by the present invention, when comparing with other previous conventional technologies, has following advantages:

1. The present invention provides a smart multifunction video-on-demand technology capable of capturing the desired image data at any time such that this monitor and control system is intellectualized.

2. The present invention integrates the digital monitoring technology and the video-on-demand technology such that the image data can be effectively employed in diversity.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A remote video-on-demand digital monitoring system comprising one or more image capture modules, a server relay module and a video-on-demand module, wherein said image capture modules are employed to capture images, and video image data are transmitted to said server relay module through a telecommunication network; when a video-on-demand item in a server side is selected by a remote monitoring computer through said telecommunication network, said video-on-demand module is automatically download to a client for execution; and in response to a control command transmitted from said video-on-demand module to said server relay module, said server relay module downloads said video image data to said client.

2. The remote video-on-demand digital monitoring system according to claim 1, wherein said server relay module and said video-on-demand module are located in said server side.

3. The remote video-on-demand digital monitoring system according to claim 1, wherein said control command from said video-on-demand module notifies said server relay module by Socket or other means through said telecommunication network, and said server relay module analyses said Socket data or other data, and download said video image data to said client.

4. The remote video-on-demand digital monitoring system according to claim 1, wherein after said image data are completely downloaded, according to the selection of said control commands of said video-on-demand module by a user, associated operations are optionally performed to broadcast, record, fast-forward play, backward play, pause or stop said video image data.

5. The remote video-on-demand digital monitoring system according to claim 1, wherein a new image data in said server relay module is optionally searched in response to said control command of said video-on-demand module.

6. The remote video-on-demand digital monitoring system according to claim 1, wherein the image data associated with the date and/or the place and/or the time segment and/or the event and/or other key values are optionally searched in response to said control command of said video-on-demand module.

7. The remote video-on-demand digital monitoring system according to claim 1, wherein after said user employs said video-on-demand module to select the date and/or the place and/or the time segment and/or the event and/or other key values to be searched, said video-on-demand module is automatically in communication with said server relay module and checks whether there are image data associated with the date and/or the place and/or the time segment and/or the event and/or other key values, if no image data are detected, an end message is sent so as to terminate the communication with said server relay module, if image data to be searched are detected, said images are transmitted to said video-on-demand module in unitary frame or several consecutive frames, during transmission of said image data, said video-on-demand module returns a message indicating that said frame has been received, if the transmission is abortive, said server relay module resents the same frame to said video-on-demand module, if all frames are completely sent out, said server relay module sends said end message to terminate the communication with said video-on-demand module.

8. The remote video-on-demand digital monitoring system according to claim 1, wherein said user directly views the downloaded images on a terminal during the transmission of said image data.

9. The remote video-on-demand digital monitoring system according to claim 1, wherein after said image data are downloaded, said user uses ScrollBar or other means to scroll to a desirable location and broadcasts said image data at a selected broadcast speed; during the period of broadcast, said user selects the recording function so as to achieve the purpose of simultaneous broadcast and recording functions.

10. The remote video-on-demand digital monitoring system according to claim 1, wherein said image data includes a note associated with said image data.

11. The remote video-on-demand digital monitoring system according to claim 10, wherein said note includes a vehicle identification number of a vehicle appearing in image or any other identification mode of said vehicle.

12. The remote video-on-demand digital monitoring system according to claim 10, said note includes the date and/or the place and/or the time and/or the event of the image captured.
